(19) United States
(12) Patent Application Publication
(10) Pub. No.: US 2009/0179972 A1
(43) Pub. Date: Jul. 16, 2009

(54) LIQUID SUPPLYING METHOD, LIQUID SUPPLYING SYSTEM, AND LIQUID EJECTING APPARATUS

(75) Inventor: Taisuke YAMAMOTO, Matsumoto-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/354,123

(22) Filed: Jan. 15, 2009

(30) Foreign Application Priority Data
Jan. 16, 2008 (JP) 2008-007093

(51) Int. Cl. B41J 2/175

(52) U.S. Cl. 347/85

(57) ABSTRACT

In a case where the depressurizer is driven so as to enable removal of any of the liquid containers for replacement in a state where the pressurized fluid is supplied through the pressurized-fluid passage to the individual liquid containers, the control section controls the individual open or closed states of the pressurization passage valve corresponding to a to-be-replaced liquid container that is to be removed for replacement and the pressurization passage valve corresponding to a remaining liquid container that continues to be used to become opposite to each other.

### BACKGROUND

1. Technical Field

The present invention relates to liquid ejecting apparatuses, such as ink jet printers, liquid supplying systems included in the liquid ejecting apparatuses, and liquid supplying methods.

2. Related Art

Ink jet printers (hereinafter referred to as “printers”) are widely known as liquid ejecting apparatuses that eject liquid toward targets. In printers of this type, ink (liquid) supplied to a recording head (liquid ejecting head) is ejected from nozzles provided to the recording head, whereby printing is performed on a recording medium, i.e., the target. Particularly, in recently proposed printers including the one disclosed in JP-A-2006-159663, pressurized air is supplied from a pressurizing pump (pressurizer) whereby ink contained in an ink cartridge (liquid container) is pressurized and is supplied through an ink passage (liquid supplying passage) to a recording head.

Specifically, in the printer disclosed in JP-A-2006-159663, a plurality of ink cartridges are connected in series to a pressurizing pump through an air passage (pressurized-fluid passage) made of a silicon tube or the like. When the pressurizing pump is driven, ink in the ink cartridges is pressurized by pressurized air supplied from the pressurizing pump, whereby the ink is supplied to a recording head.

In the printer disclosed in JP-A-2006-159663, a single air passage, made of a silicon tube, sequentially connects all of the ink cartridges in series. Therefore, when the pressurizing pump is driven, all of the ink cartridges are pressurized uniformly. If air in the air passage is released to atmosphere for the purpose of replacing any of the ink cartridges or the like, the pressurizing force that has been applied to the ink in all of the ink cartridges is reduced to atmosphere. Hence, in such an ink supplying system, during replacement of any ink cartridges, pressurization and supply of ink to the recording head is not performed, resulting in disability in performing printing.

### SUMMARY

An advantage of some aspects of the invention is that it provides a liquid supplying method, a liquid supplying system, and a liquid ejecting apparatus enabling liquid to be continuously pressurized and supplied, even during replacement of a to-be-replaced liquid container, i.e., a liquid container that needs to be removed for replacement, from remaining liquid containers, i.e., liquid containers other than the to-be-replaced one, toward a downstream position where the liquid is consumed.

According to a first aspect of the invention, a liquid supplying system includes a pressurized-fluid passage having in a downstream portion thereof a plurality of branches connected in parallel respectively to a plurality of liquid containers containing liquid, the branches allowing pressurized fluid to be supplied to the individual liquid containers; a liquid supplying passage having in an upstream portion thereof a plurality of branches connected in parallel to the respective liquid containers, the branches allowing the liquid to be supplied from the individual liquid containers toward a downstream position where the liquid is consumed; a plurality of pressurization passage valves provided in the respective branches of the pressurized-fluid passage; a depressurizer configured to be driven so as to depressurize an interior of the pressurized-fluid passage; and a control section capable of controlling individual open or closed states of the pressurization passage valves. In a case where the depressurizer is driven so as to enable removal of any of the liquid containers for replacement in a state where the pressurized fluid is supplied through the pressurized-fluid passage to the individual liquid containers, the control section controls the individual open or closed states of the pressurization passage valve corresponding to a to-be-replaced liquid container that is to be removed for replacement and the pressurization passage valve corresponding to a remaining liquid container that continues to be used to become opposite to each other.

With such a configuration, if any of the liquid containers needs to be removed for replacement in a state where pressurized fluid has been supplied to the liquid containers, the control section controls, before the depressurizer is driven, the individual open/closed states of the pressurization passage valve corresponding to the to-be-replaced liquid container, which needs to be replaced, and the pressurization passage valve corresponding to the remaining liquid container, which do not need to be replaced. Specifically, to prevent pressure change that is to occur at the subsequent driving of the depressurizer from affecting the remaining liquid container, the open/closed state of the pressurization passage valve corresponding to the to-be-replaced liquid container and the open/closed state of the pressurization passage valve corresponding to the remaining liquid container are controlled in such a manner as to be opposite to each other. Thus, the liquid can continue to be pneumatically supplied from the remaining liquid container other than the to-be-replaced liquid container, to the downstream position where the liquid is consumed, even during replacement of any of the liquid containers.

In the liquid supplying system according to the first aspect of the invention, it is preferable that the liquid containers include a plurality of same-kind liquid containers containing liquid of a same kind and at least one liquid container containing liquid of a different kind from that in the same-kind liquid containers, the same-kind liquid containers including an in-use same-kind liquid container to which the pressurized fluid is supplied through the pressurized-fluid passage so that the liquid is supplied through the liquid supplying passage to the downstream position and a standby same-kind liquid container for which supply of the pressurized fluid is being withheld. It is also preferable that, in a case where the to-be-replaced liquid container is the in-use same-kind liquid container, the control section control the individual open or closed states of the pressurization passage valve corresponding to the in-use same-kind liquid container and the pressurization passage valves corresponding to the remaining liquid containers including the standby same-kind liquid container to become opposite to each other.

With such a configuration, in a case where the in-use one of the same-kind liquid containers containing the liquid of the same kind needs to be removed for replacement, the liquid supplying source, from which the liquid of the same kind is supplied to the downstream position where the liquid is consumed, is switched from the in-use same-kind liquid container to the standby same-kind liquid container before the in-use same-kind liquid container is removed. This enables continuous pneumatic supply of the liquid of the same kind, without any interruptions, to the downstream position where the liquid is consumed even during replacement of any of the same-kind liquid containers.

In the liquid supplying system according to the first aspect of the invention, it is also preferable that the depressurizer be disposed in an upstream portion of the pressurized-fluid passage with respect to the pressurization passage valves, and that, in a case where the depressurizer depressurizes the interior of the pressurized-fluid passage so that the to-be-replaced liquid container is removed for replacement, the control section control the pressurization passage valve corresponding to the to-be-replaced liquid container to be opened and the pressurization passage valve corresponding to the remaining liquid container to be closed.

With such a configuration, if the pressurization passage valves are all open when the depressurizer is driven, the liquid containers corresponding to the respective pressurization passage valves are all affected by the pressure change due to the driving of the depressurizer. However, before the depressurizer is driven, the control section controls the pressurization passage valve corresponding to the to-be-replaced liquid container to be opened, while the control section controls the pressurization passage valve corresponding to the remaining liquid container to be closed. Therefore, the pressure change occurring at the driving of the depressurizer does not affect the remaining liquid container because the corresponding pressurization passage valve is closed. Consequently, the liquid can continue to be pneumatically supplied from the remaining liquid container to the downstream position.

In the liquid supplying system according to the first aspect of the invention, it is also preferable that the depressurizer be controlled to be driven by the control section, the control section driving the depressurizer, before the to-be-replaced liquid container is removed for replacement, after controlling the individual open or closed states of the pressurization passage valves.

With such a configuration, before the depressurizer is driven, the control section controls the open/closed states of the pressurization passage valve corresponding to the to-be-replaced liquid container and the pressurization passage valve corresponding to the remaining liquid container. Therefore, continuous pneumatic liquid supply from the remaining liquid container to the downstream position and replacement of the to-be-replaced liquid container can be performed quickly and easily.

In the liquid supplying system according to the first aspect of the invention, it is also preferable that the liquid supplying system further include a plurality of liquid passage valves provided to the respective branches of the liquid supplying passage. In this case, before the to-be-replaced liquid container is removed for replacement, the control section controls the liquid passage valve corresponding to the to-be-replaced liquid container to be closed and the liquid passage valve corresponding to the remaining liquid container to be opened.

If the liquid passage valves are all open when the to-be-replaced liquid container is to be removed for replacement, the liquid may leak from the branch of the liquid supplying passage connected to the to-be-replaced liquid container. To avoid this, in the foregoing preferable configuration, before the to-be-replaced liquid container is removed for replacement, the control section controls the open/closed states of the liquid passage valves in such a manner that the liquid passage valve corresponding to the to-be-replaced liquid container is closed while the liquid passage valve corresponding to the remaining liquid container is opened. Therefore, while liquid leakage from the branch corresponding to the to-be-replaced liquid container is prevented, the liquid can continue to be pneumatically supplied from the remaining liquid container through the corresponding branch to the downstream position.

In the liquid supplying system according to the first aspect of the invention, it is also preferable that the liquid supplying system further include a remaining-liquid-amount detector that detects amounts of liquid remaining in the liquid containers. In this case, the control section identifies the to-be-replaced liquid container among all of the liquid containers in accordance with a result of detection performed by the remaining-liquid-amount detector.

With such a configuration, in accordance with the result of detection performed by the remaining-liquid-amount detector, the control section can easily identify the to-be-replaced liquid container that needs to be removed for replacement. Further, in accordance with the identification result, the control section can quickly control the open/closed states of the pressurization passage valves.

In the liquid supplying system according to the first aspect of the invention, it is also preferable that the depressurizer be provided to each of the branches of the pressurized-fluid passage, between corresponding one of the pressurization passage valves and corresponding one of the liquid containers. It is also preferable that, in a case where the depressurizer provided to the branch corresponding to the to-be-replaced liquid container depressurizes the interior of the branch so that the to-be-replaced liquid container is removed for replacement, the control section control the pressurization passage valve corresponding to the to-be-replaced liquid container to be closed and the pressurization passage valve corresponding to the remaining liquid container to be opened.

If the to-be-replaced liquid container is removed after the depressurizer provided to the branch of the pressurized-fluid passage corresponding to the to-be-replaced liquid container is driven, the entirety of the pressurized-fluid passage is released to atmosphere through the branch corresponding to the to-be-replaced liquid container. Therefore, the liquid cannot be pneumatically supplied from the remaining liquid container to the downstream position. However, in the foregoing preferable configuration, the control section controls the open/closed states of the pressurization passage valves in such a manner that, before the depressurizer provided to the branch corresponding to the to-be-replaced liquid container is driven, the pressurization passage valve corresponding to the to-be-replaced liquid container is closed and the pressurization passage valve corresponding to the remaining liquid container is opened. Therefore, even during replacement of the to-be-replaced liquid container, the liquid can continue to be pneumatically supplied from the remaining liquid container to the downstream position.

According to a second aspect of the invention, a liquid ejecting apparatus includes a liquid ejecting head that ejects liquid, and the liquid supplying system according to the first aspect of the invention that supplies the liquid to the liquid ejecting head.

With such a configuration, the liquid can continue to be ejected from the liquid ejecting head even during replacement of any of the liquid containers.

According to a third aspect of the invention, a liquid supplying method includes pneumatically supplying liquid from a plurality of liquid containers containing the liquid through a liquid supplying passage toward a downstream position where the liquid is consumed, by supplying pressurized fluid through a pressurized-fluid passage to the liquid containers. In this method, supply of the pressurized fluid through the pressurized-fluid passage to the liquid containers is performed independently for the individual liquid containers. Further, in a case where depressurization of an interior of the pressurized-fluid passage is performed so that any of the liquid containers is removed for replacement, the depressurization is performed in such a manner that a remaining liquid container other than a to-be-replaced liquid container that is to be removed for replacement is free from an effect of pressure change resulting from the depressurization.

By such a method, the same advantageous effects as those produced by the liquid supplying system described above can be produced.

### BRIEF DESCRIPTION OF THE DRAWINGS

The invention will be described with reference to the accompanying drawings, wherein like numbers reference like elements.

FIG. 1 schematically shows an ink jet printer according to a first embodiment of the invention.

FIG. 2 schematically shows an ink supplying system included in the printer.

FIG. 3 is a block diagram of a control device.

FIG. 4 is a flowchart showing a power-on routine.

FIG. 5 is a flowchart showing an ink-cartridge-replacement routine.

FIG. 6 schematically shows an ink supplying system included in a printer according to a second embodiment.

FIG. 7 is a flowchart showing a power-on routine.

FIG. 8 is a flowchart showing an ink-cartridge-replacement routine.

### DESCRIPTION OF EXEMPLARY EMBODIMENTS

### First Embodiment

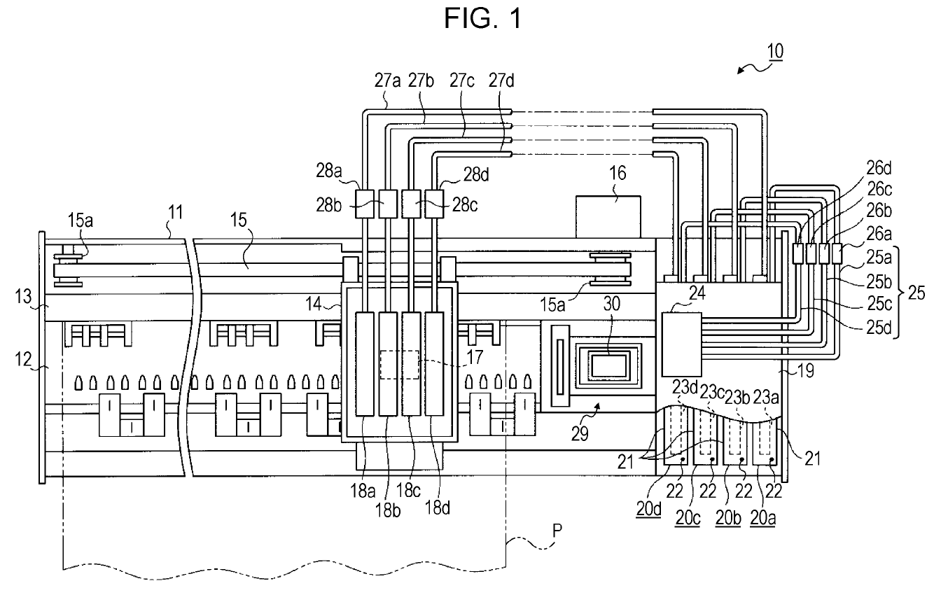

A first embodiment of the invention will now be described with reference to FIGS. 1 to 5, in which the invention is embodied in the form of an ink jet printer (hereinafter referred to as a “printer”), as an example of a liquid ejecting apparatus, including an ink supplying system, as an example of a liquid supplying system.

Referring to FIG. 1, a printer 10 includes, in a frame 11, a platen 12 extending therein and onto which recording paper P is fed by a paper feeding mechanism (not shown) having a paper feeding motor, and a stick-like guide member 13 extending therein parallel to the platen 12 in the longitudinal direction thereof.

The guide member 13 supports a carriage 14 in such a manner that the carriage 14 can move back and forth along the axis of the guide member 13. The carriage 14 is connected to a carriage motor 16 with a timing belt 15 interposed therebetween, the timing belt 15 being stretched between a pair of pulleys 15a. In response to driving of the carriage motor 16, the carriage 14 moves back and forth along the guide member 13.

The carriage 14 has on a surface thereof facing the platen 12 a recording head 17, as a liquid ejecting head, that consumes ink, as liquid, by ejection thereof. The carriage 14 also has a plurality (four in the first embodiment) of valve units, i.e., first to fourth valve units 18a to 18d, provided in correspondence with colors (kinds) of ink to be used in the printer 10. The first to fourth valve units 18a to 18d supply the ink to the recording head 17 by adjusting the pressure applied to the ink. Ink droplets are ejected from nozzles (not shown) provided in a bottom surface (nozzle surface) of the recording head 17 toward the recording paper P that has been fed onto the platen 12. Thus, printing is performed.

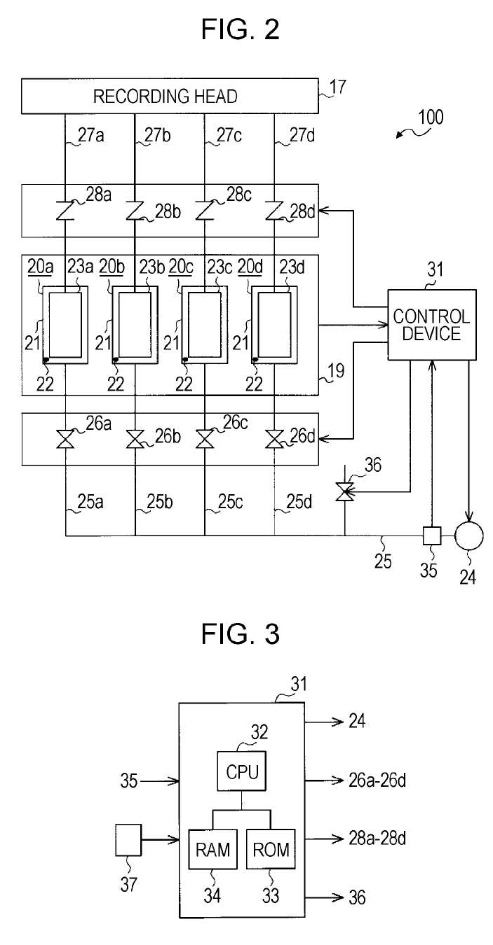

Referring to FIG. 1, a cartridge holder 19 is disposed on the right end of the frame 11. Referring to FIGS. 1 and 2, the cartridge holder 19, which is included in an ink supplying system 100, removably holds a plurality (four in the first embodiment) of liquid containers, i.e., first to fourth ink cartridges 20a to 20d. The first to fourth ink cartridges 20a to 20d each include a case 21 having a rectangular cross-section. The case 21 has an air chamber 22 thereinside. The air chamber 22 houses corresponding one of first to fourth ink packs 23a to 23d each made of flexible film and having a bag-like shape.

The first ink pack 23a contains a black ink, the second ink pack 23b contains a yellow ink, the third ink pack 23c contains a cyan ink, and the fourth ink pack 23d contains a magenta ink. In short, the first to fourth ink packs 23a to 23d contain inks of different colors.

Referring to FIG. 1, a pressurizing pump 24 is disposed near the cartridge holder 19. The pressurizing pump 24 is connected to the first to fourth ink cartridges 20a to 20d via an air supplying tube 25, as a pressurized-fluid passage. Specifically, the air supplying tube 25 is connected at the upstream end thereof to the pressurizing pump 24 and branches off in the downstream portion thereof into a plurality (four in the first embodiment) of passages, which are hereinafter referred to as first to fourth air supplying tubes 25a to 25d. The first to fourth air supplying tubes 25a to 25d are connected in parallel respectively to the air chambers 22 of the first to fourth ink cartridges 20a to 20d.

More specifically, the first air supplying tube 25a is connected to the air chamber 22 of the first ink cartridge 20a housing the first ink pack 23a, the second air supplying tube 25b is connected to the air chamber 22 of the second ink cartridge 20b housing the second ink pack 23b, the third air supplying tube 25c is connected to the air chamber 22 of the third ink cartridge 20c housing the third ink pack 23c, and the fourth air supplying tube 25d is connected to the air chamber 22 of the fourth ink cartridge 20d housing the fourth ink pack 23d.

The first to fourth air supplying tubes 25a to 25d, which are the downstream portions of the air supplying tube 25, are provided at halfway positions thereof with first to fourth pressurization passage valves 26a to 26d, respectively. The first to fourth pressurization passage valves 26a to 26d can open and close the first to fourth air supplying tubes 25a to 25d. When the first to fourth pressurization passage valves 26a to 26d are open, pressurized air, as pressurized fluid, can be supplied through the first to fourth air supplying tubes 25a to 25d to the air chambers 22 in the cases 21 of the first to fourth ink cartridges 20a to 20d (see FIG. 2).

First to fourth ink supplying tubes 27a to 27d, as liquid supplying passages, are connected in parallel at the upstream ends thereof to the first to fourth ink cartridges 20a to 20d, respectively. Specifically, the first ink supplying tube 27a is connected to the first ink pack 23a in the first ink cartridge 20a, the second ink supplying tube 27b is connected to the second ink pack 23b in the second ink cartridge 20b, the third ink supplying tube 27c is connected to the third ink pack 23c in the third ink cartridge 20c, and the fourth ink supplying tube 27d is connected to the fourth ink pack 23d in the fourth ink cartridge 20d. The first to fourth ink supplying tubes 27a to 27d are also connected at the downstream ends thereof to the first to fourth valve units 18a to 18d, respectively.

The first to fourth ink supplying tubes 27a to 27d are provided at halfway positions thereof between the first to fourth ink cartridges 20a to 20d and the first to fourth valve units 18a to 18d with first to fourth ink passage valves 28a to 28d, respectively, as liquid passage valves that can open and close the first to fourth ink supplying tubes 27a to 27d. When the first to fourth ink passage valves 28a to 28d are open, the inks can be supplied from the first to fourth ink cartridges 20a to 20d through the first to fourth ink supplying tubes 27a to 27d and the first to fourth valve units 18a to 18d to the recording head 17 (see FIG. 2).

Accordingly, when the pressurizing pump 24 is driven in a state where the first to fourth pressurization passage valves 26a to 26d are open, the pressure of pressurized air supplied from the pressurizing pump 24 through the air supplying tube 25 (25a to 25d) to the air chambers 22 of the first to fourth ink cartridges 20a to 20d causes the first to fourth ink packs 23a to 23d to be squeezed. Subsequently, if the first to fourth ink passage valves 28a to 28d are open, the inks in the first to fourth ink packs 23a to 23d are pneumatically supplied through the first to fourth ink supplying tubes 27a to 27d to the first to fourth valve units 18a to 18d, respectively, the first to fourth valve units 18a to 18d adjusting the pressures applied to the inks. Thus, the inks are supplied to the recording head 17.

Referring to FIG. 2, a pressure sensor 35 and an air release valve 36 are provided at halfway positions of the air supplying tube 25 (25a to 25d), between the pressurizing pump 24 and the first to fourth pressurization passage valves 26a to 26d. The pressure sensor 35 detects the pressure inside the air supplying tube 25 (25a to 25d). The air release valve 36, as a depressurizer, depressurizes the interior of the air supplying tube 25 (25a to 25d) by releasing the air thereinside to atmosphere. To remove any of the first to fourth ink cartridges 20a to 20d for replacement, the air release valve 36 is opened prior to the removal so that the air thereinside is released to atmosphere.

A maintenance unit 29 is disposed near the right end inside the frame 11, i.e., at the home position of the carriage 14. The maintenance unit 29 has a rectangular box-like shape with an open top, and has a cap 30 that can be brought into contact with the recording head 17 in such a manner as to surround the nozzles (not shown). When a suction pump (not shown) is driven in a state where the cap 30 is in contact with the recording head 17 in such a manner as to surround the nozzles, ink having an increased viscosity or the like remaining inside the recording head 17 is removed therefrom by suction into the cap 30, that is, cleaning is performed.

Referring to FIGS. 2 and 3, the printer 10 includes a control device 31, as a control section, that generally controls the operation of the printer 10. The control device 31 is a digital computer including a central processing unit (CPU) 32 that performs various arithmetic processings, and a read-only memory (ROM) 33 and a random access memory (RAM) 34 serving as storage sections. The CPU 32 controls, for example, the open/closed states of the first to fourth pressurization passage valves 26a to 26d, the first to fourth ink passage valves 28a to 28d, and the air release valve 36 in the ink supplying system 100, in accordance with the result of detection performed by the pressure sensor 35 that detects the pressure inside the air supplying tube 25 (25a to 25d) and the result of detection performed by an ink end sensor 37 (see FIG. 3), as a remaining-liquid-amount detector, that detects the amounts of respective inks remaining in the first to fourth ink cartridges 20a to 20d.

Specifically, the CPU 32 controls the driving of the pressurizing pump 24 in accordance with the result of detection performed by the pressure sensor 35 so that the inks in the first to fourth ink cartridges 20a to 20d can be pneumatically supplied to the recording head 17. The CPU 32 also identifies a to-be-replaced ink cartridge (to-be-replaced liquid container), which is any of the first to fourth ink cartridges 20a to 20d that needs to be replaced, in accordance with the result of detection performed by the ink end sensor 37. Further, the CPU 32 controls the open/closed states of the first to fourth pressurization passage valves 26a to 26d and the first to fourth ink passage valves 28a to 28d in accordance with the identification result, along with the open/closed state of the air release valve 36.

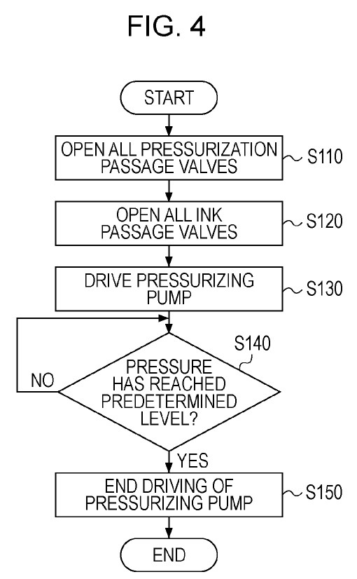

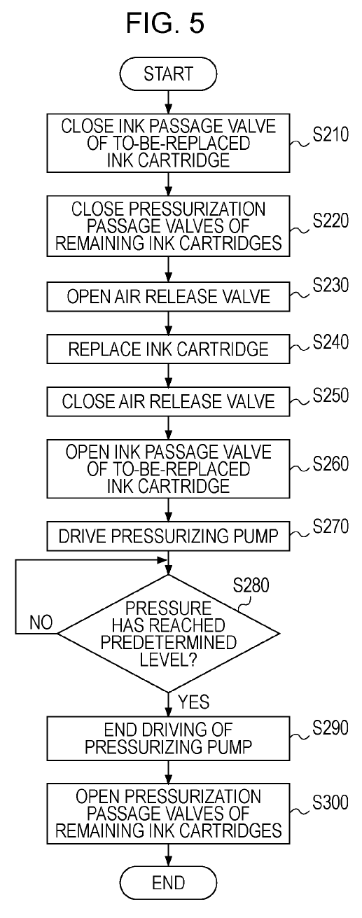

Next, control routines performed by the CPU 32 of the control device 31 will be described with reference to the flowcharts shown in FIGS. 4 and 5.

When the power of the printer 10 is turned on, the CPU 32 performs a power-on routine shown in FIG. 4. Specifically, in step S110, the CPU 32 controls a valve driving circuit (not shown) to open all of the first to fourth pressurization passage valves 26a to 26d. In response to this, the pressurizing pump 24 is made to communicate with the air chambers 22 of all of the first to fourth ink cartridges 20a to 20d through the air supplying tube 25 (25a to 25d).

In subsequent step S120, the CPU 32 controls the valve driving circuit to open all of the first to fourth ink passage valves 28a to 28d. This produces a state where the inks are ready to be supplied from the first to fourth ink packs 23a to 23d in the first to fourth ink cartridges 20a to 20d through the first to fourth ink supplying tubes 27a to 27d to the recording head 17.

In this state, in subsequent step S130, the CPU 32 causes a driving motor (not shown) to rotate so that the pressurizing pump 24 is driven. In response to this, pressurized air flows through the air supplying tube 25 (25a to 25d) into the air chambers 22 of the first to fourth ink cartridges 20a to 20d. In accordance with the result of detection performed by the pressure sensor 35, the CPU 32 continues to drive the pressurizing pump 24 (NO in step S140) until the pressure inside the air supplying tube 25 (25a to 25d) reaches a predetermined level sufficient for pneumatically supplying the inks from the first to fourth ink cartridges 20a to 20d to the recording head 17.

When the pressure sensor 35 detects that the pressure inside the air supplying tube 25 (25a to 25d) has reached the predetermined level (YES in step S140), in subsequent step S150, the CPU 32 ends the driving of the pressurizing pump 24. In this state, the first to fourth ink packs 23a to 23d in the first to fourth ink cartridges 20a to 20d are pressurized and squeezed by the pressurized air supplied at a pressure of the predetermined level, whereby the inks in a pressurized state are supplied through the first to fourth ink supplying tubes 27a to 27d, respectively, to the recording head 17.

When the pressure sensor 35 detects that the pressure inside the air supplying tube 25 (25a to 25d) has been reduced from the predetermined level to a predetermined lower limit, the CPU 32 drives the pressurizing pump 24 again. If the air release valve 36 is open at the start of the power-on routine shown in FIG. 4, the CPU 32 causes the air release valve 36 to be closed before performing step silo.

As the inks in the first to fourth ink packs 23a to 23d are consumed while being ejected from the recording head 17, the remaining amount of ink in any of the first to fourth ink packs 23a to 23d becomes zero, i.e., an ink end state. The ink end sensor 37 detects such an ink end state. In response to this, the CPU 32 identifies the relevant ink cartridge that needs to be removed for replacement, i.e., the to-be-replaced ink cartridge, in accordance with the result of detection performed by the ink end sensor 37. After the identification, the CPU 32 performs a replacement routine shown in FIG. 5.

The replacement routine will be described, taking as an example a case where the first ink cartridge 20a is identified as the to-be-replaced ink cartridge that needs to be removed for replacement.

When the replacement routine shown in FIG. 5 is started, in step S210, the CPU 32 controls the valve driving circuit to close the first ink passage valve 28a corresponding to the first ink cartridge 20a, which has been identified as the to-be-replaced ink cartridge. In subsequent step S220, the CPU 32 controls the valve driving circuit to close the second to fourth pressurization passage valves 26b to 26d respectively corresponding to the second to fourth ink cartridges 20b to 20d, as remaining ink cartridges (remaining liquid containers), other than the first ink cartridge 20a.

In subsequent step S230, the CPU 32 causes the air release valve 36 to be opened. In this state, since the first pressurization passage valve 26a corresponding to the first ink cartridge 20a, which is to be removed for replacement, is open, the pressure inside the air chamber 22 of the first ink cartridge 20a is reduced to be equal to atmosphere. Further, since the first ink passage valve 28a corresponding to the first ink cartridge 20a is closed, the ink will not leak from the first ink supplying tube 27a even if the first ink cartridge 20a is removed from the cartridge holder 19.

On the other hand, the air chambers 22 of the second to fourth ink cartridges 20b to 20d retain the pressurized air therein because the second to fourth pressurization passage valves 26b to 26d are closed. Further, since the second to fourth ink passage valves 28b to 28d remain opened, the inks in these remaining ink cartridges (second to fourth ink cartridges 20b to 20d) can continue to be supplied to the recording head 17.

In step S240, the CPU 32 detects that the first ink cartridge 20a in the ink end state has been removed and replaced with a new one containing the same black ink. In subsequent step S250, the CPU 32 causes the air release valve 36 to be closed. The detection of whether or not the first ink cartridge 20a has been removed and replaced with a new one is made on the basis of, for example, whether or not the connection between a terminal of a circuit board (not shown) provided to each ink cartridge and a terminal strip (not shown) provided to the cartridge holder 19 is cut.

In subsequent step S260, the CPU 32 controls the valve driving circuit to open the first ink passage valve 28a corresponding to the new first ink cartridge 20a. Further, in step S270, the CPU 32 controls the driving motor to drive the pressurizing pump 24. In response to this, pressurized air flows through the first pressurization passage valve 26a, which is open, into the air chamber 22 of the first ink cartridge 20a and pressurizes the first ink pack 23a, whereby the ink contained therein can be supplied to the recording head 17.

In subsequent step S280, the CPU 32 continues to drive the pressurizing pump 24 (NO in step S280) until the pressure inside the air supplying tube 25 (25a to 25d) reaches the predetermined level, in accordance with the result of detection performed by the pressure sensor 35. When the pressure sensor 35 detects that the pressure has reached the predetermined level (YES in step S280), in subsequent step S290, the CPU 32 ends the driving of the pressurizing pump 24. Then, in step S300, the CPU 32 causes the second to fourth pressurization passage valves 26b to 26d to be opened.

Now, advantageous effects produced by the ink supplying system 100 included in the printer 10 configured as above will be described, focusing on effects obtained in relation to removal and replacement of an ink cartridge. The following description is based on the premise that the first to fourth pressurization passage valves 26a to 26d provided to the first to fourth air supplying tubes 25a to 25d and the first to fourth ink passage valves 28a to 28d provided to the first to fourth ink supplying tubes 27a to 27d are all open.

On this premise, if the remaining amount of ink in any of the first to fourth ink cartridges 20a to 20d shows the ink end state, the relevant ink cartridge in the ink end state needs to be removed for replacement with a new one containing the same ink. For example, a case where the first ink cartridge 20a containing the black ink is identified as the to-be-replaced ink cartridge that needs to be removed for replacement will be described. To begin with, the first ink passage valve 28a of the first ink supplying tube 27a corresponding to the first ink cartridge 20a is closed. This is to prevent the ink in the first ink supplying tube 27a from leaking out when the first ink cartridge 20a is removed from the cartridge holder 19.

On the other hand, the second to fourth pressurization passage valves 26b to 26d of the second to fourth air supplying tubes 25b to 25d corresponding to the second to fourth ink cartridges 20b to 20d, as the remaining ink cartridges that do not need to be replaced, are closed. This is because of the following reason. Before the first ink cartridge 20a is removed for replacement, the air release valve 36 is opened. When the air release valve 36 is opened, pressure change, i.e., depressurization to atmosphere, occurs in the air supplying tube 25 (25a to 25d). This pressure change needs to be prevented from affecting the interiors of the air chambers 22 of the second to fourth ink cartridges 20b to 20d.

After the first ink passage valve 28a and the second to fourth pressurization passage valves 26b to 26d are all closed as described above, the air release valve 36 is opened. In response to this, the air chamber 22 of the first ink cartridge 20a in the ink end state is depressurized to atmosphere. In this state, the first ink cartridge 20a can be removed and replaced with a new one without leakage of the ink from the first ink pack 23a when removed from the cartridge holder 19.

On the other hand, the interiors of the air chambers 22 of the second to fourth ink cartridges 20b to 20d, as the remaining ink cartridges, remains being pressurized. Therefore, the inks continue to be pneumatically supplied, without any interruptions, from the second to fourth ink cartridges 20b to 20d to the recording head 17 even during the replacement of the first ink cartridge 20a. When the replacement of the first ink cartridge 20a is finished, the pressurizing pump 24 is driven and pressurized air is supplied to the air chamber 22 of the new first ink cartridge 20a so that ink contained therein can be pneumatically supplied also from the new first ink cartridge 20a toward a downstream position. When the pressure inside the air chamber 22 of the new first ink cartridge 20a has reached the predetermined level, the driving of the pressurizing pump 24 is ended, the second to fourth pressurization passage valves 26b to 26d that have been closed are opened again, and the state before the replacement of the ink cartridge is resumed.

According to the first embodiment, the following advantageous effects are produced.

(1) If the first ink cartridge 20a needs to be removed for replacement in a state where pressurized air has been supplied to the air chambers 22 of the first to fourth ink cartridges 20a to 20d and the inks in the first to fourth ink packs 23a to 23d have been pressurized, the control device 31 controls, before opening the air release valve 36, the individual open/closed states of the first pressurization passage valve 26a corresponding to the first ink cartridge 20a, which needs to be replaced, and the second to fourth pressurization passage valves 26b to 26d corresponding to the second to fourth ink cartridges 20b to 20d, which do not need to be replaced. Specifically, to prevent pressure change that is to occur at the pressure reduction to atmosphere accompanying the subsequent opening of the air release valve 36 from affecting the second to fourth ink cartridges 20b to 20d, the open/closed state of the first pressurization passage valve 26a corresponding to the first ink cartridge 20a and the open/closed states of the second to fourth pressurization passage valves 26b to 26d corresponding to the second to fourth ink cartridges 20b to 20d, which do not need to be replaced, are controlled in such a manner as to be opposite to each other. Thus, the inks can continue to be pneumatically supplied from the second to fourth ink cartridges 20b to 20d, other than the first ink cartridge 20a to be replaced, toward the downstream position where the inks are consumed, even during replacement of the first ink cartridge 20a.

(2) In a case where the pressure is reduced to atmosphere by opening the air release valve 36, if the first to fourth pressurization passage valves 26a to 26d are all open, the first to fourth ink cartridges 20a to 20d respectively corresponding to the first to fourth pressurization passage valves 26a to 26d are all affected by the pressure change due to the air releasing. However, before opening the air release valve 36, the control device 31 controls the first pressurization passage valve 26a corresponding to the first ink cartridge 20a to be opened, while the control device 31 controls the second to fourth pressurization passage valves 26b to 26d corresponding to the second to fourth ink cartridges 20b to 20d to be closed. Therefore, the pressure change, i.e., depressurization, occurring at the opening of the air release valve 36 does not affect the second to fourth ink cartridges 20b to 20d because the corresponding second to fourth pressurization passage valves 26b to 26d are closed. Consequently, the inks can continue to be pneumatically supplied from the second to fourth ink cartridges 20b to 20d toward the downstream position.

(3) Before opening the air release valve 36, the control device 31 controls the open/closed states of the first pressurization passage valve 26a corresponding to the first ink cartridge 20a, which needs to be replaced, and the second to fourth pressurization passage valves 26b to 26d corresponding to the second to fourth ink cartridges 20b to 20d, which do not needs to be replaced. Therefore, continuous pneumatic ink supply from the second to fourth ink cartridges 20b to 20d toward the downstream position and replacement of the first ink cartridge 20a can be performed quickly and easily.

(4) If the first ink passage valves 28a to 28d are all open when the first ink cartridge 20a, for example, is to be replaced, the ink may leak from the first ink supplying tube 27a connected to the first ink cartridge 20a that is to be replaced. To avoid this, before the first ink cartridge 20a is removed for replacement, the control device 31 controls the open/closed states of the first to fourth ink passage valves 28a to 28d in such a manner that the first ink passage valve 28a corresponding to the first ink cartridge 20a is closed while the second to fourth ink passage valves 28b to 28d corresponding to the second to fourth ink cartridges 20b to 20d are opened. Therefore, while ink leakage from the first ink supplying tube 27a corresponding to the first ink cartridge 20a is prevented, the other inks can continue to be pneumatically supplied from the second to fourth ink cartridges 20b to 20d through the corresponding passages toward the downstream position.

(5) In accordance with the result of detection performed by the ink end sensor 37, the control device 31 can easily identify any of the first to fourth ink cartridges 20a to 20d that needs to be removed for replacement. Further, in accordance with the identification result, the control device 31 can quickly control the open/closed states of the first to fourth pressurization passage valves 26a to 26d.

(6) Even during replacement of any of the first to fourth ink cartridges 20a to 20d, the inks can continue to be ejected from the recording head 17.

### Second Embodiment

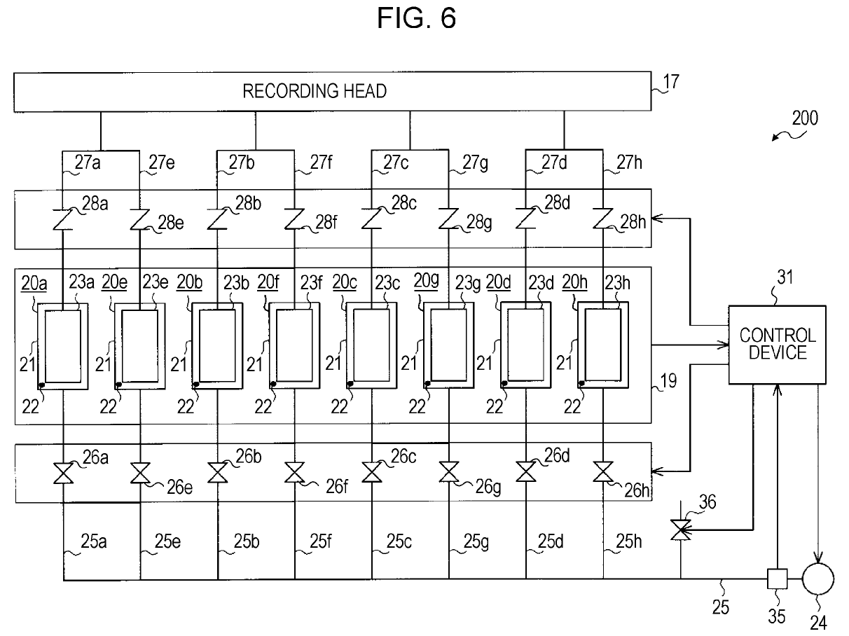

A second embodiment of the invention will now be described with reference to FIGS. 6 to 8. The second embodiment only differs from the first embodiment in that there are a plurality of ink cartridges containing the same ink. The other details are common to the first embodiment. Therefore, similar elements are denoted by the same reference numerals and detailed descriptions thereof will be omitted.

Referring to FIG. 6, an ink supplying system 200 according to the second embodiment includes a plurality (two in the second embodiment) of same-color ink cartridges, as same-kind liquid containers, that contain ink of the same color for each of the ink colors.

Specifically, a fifth ink cartridge 20e housing a fifth ink pack 23e containing the black ink, a sixth ink cartridge 20f housing a sixth ink pack 23f containing the yellow ink, a seventh ink cartridge 20g housing a seventh ink pack 23g containing the cyan ink, and an eighth ink cartridge 20h housing an eighth ink pack 23h containing the magenta ink are removably mounted on the cartridge holder 19, in parallel with the first to fourth ink cartridges 20a to 20d, respectively.

The air supplying tube 25, whose upstream end is connected to the pressurizing pump 24, branches off in the downstream portion thereof into a plurality (eight in the second embodiment) of passages, which are hereinafter referred to as first to eighth air supplying tubes 25a to 25h. The first to eighth air supplying tubes 25a to 25h are connected in parallel to the air chambers 22 of the first to eighth ink cartridges 20a to 20h, respectively.

Specifically, the fifth air supplying tube 25e is connected to the air chamber 22 of the fifth ink cartridge 20e housing the fifth ink pack 23e, the sixth air supplying tube 25f is connected to the air chamber 22 of the sixth ink cartridge 20f housing the sixth ink pack 23f, the seventh air supplying tube 25g is connected to the air chamber 22 of the seventh ink cartridge 20g housing the seventh ink pack 23g, and the eighth air supplying tube 25h is connected to the air chamber 22 of the eighth ink cartridge 20h housing the eighth ink pack 23h.

The first to eighth air supplying tubes 25a to 25h, which are the downstream portions of the air supplying tube 25, are provided at halfway positions thereof with first to eighth pressurization passage valves 26a to 26h, respectively, that can open and close the first to eighth air supplying tubes 25a to 25h. When the first to eighth pressurization passage valves 26a to 26h are open, pressurized air can be supplied through the first to eighth air supplying tubes 25a to 25h to the air chambers 22 in the cases 21 of the first to eighth ink cartridges 20a to 20h.

The ink supplying tube for each of the ink colors has on the upstream portion thereof a plurality (two in the second embodiment) of branches, in correspondence with the same-color ink cartridges. In total, first to eighth ink supplying tubes 27a to 27h are provided. The first to eighth ink supplying tubes 27a to 27h are connected to the first to eighth ink cartridges 20a to 20h, respectively, in such a manner that the same-color ink cartridges are connected in parallel.

Specifically, the upstream end of the first ink supplying tube 27a is connected to the first ink pack 23a in the first ink cartridge 20a, the upstream end of the fifth ink supplying tube 27e is connected to the fifth ink pack 23e in the fifth ink cartridge 20e, and the first ink supplying tube 27a and the fifth ink supplying tube 27e converge in the downstream portions thereof to form a single line.

Likewise, the upstream end of the second ink supplying tube 27b is connected to the second ink pack 23b in the second ink cartridge 20b, the upstream end of the sixth ink supplying tube 27f is connected to the sixth ink pack 23f in the sixth ink cartridge 20f, and the second ink supplying tube 27b and the sixth ink supplying tube 27f converge in the downstream portions thereof to form a single line. Further, the upstream end of the third ink supplying tube 27c is connected to the third ink pack 23c in the third ink cartridge 20c, the upstream end of the seventh ink supplying tube 27g is connected to the seventh ink pack 23g in the seventh ink cartridge 20g, and the third ink supplying tube 27c and the seventh ink supplying tube 27g converge in the downstream portions thereof to form a single line. Further, the upstream end of the fourth ink supplying tube 27d is connected to the fourth ink pack 23d in the fourth ink cartridge 20d, the upstream end of the eighth ink supplying tube 27h is connected to the eighth ink pack 23h in the eighth ink cartridge 20h, and the fourth ink supplying tube 27d and the eighth ink supplying tube 27h converge in the downstream portions thereof to form a single line.

The converged line of the first and fifth ink supplying tubes 27a and 27e is connected at the downstream end thereof to the first valve unit 18a. The converged line of the second and sixth ink supplying tubes 27b and 27f is connected at the downstream end thereof to the second valve unit 18b. The converged line of the third and seventh ink supplying tubes 27c and 27g is connected at the downstream end thereof to the third valve unit 18c. The converged line of the fourth and eighth ink supplying tubes 27d and 27h is connected at the downstream end thereof to the fourth valve unit 18d.

The first to eighth ink supplying tubes 27a to 27h are provided with first to eighth ink passage valves 28a to 28h, respectively, at halfway positions thereof between the first to eighth ink cartridges 20a to 20h and the converging points. The first to eighth ink passage valves 28a to 28h can open and close the first to eighth ink supplying tubes 27a to 27h. When the first to eighth ink passage valves 28a to 28h are open, the inks can be supplied from the first to eighth ink cartridges 20a to 20h through the first to eighth ink supplying tubes 27a to 27h and the first to fourth valve units 18a to 18d to the recording head 17.

Accordingly, if the pressurizing pump 24 is driven in a state where the first to eighth pressurization passage valves 26a to 26h are open, the pressure of pressurized air supplied from the pressurizing pump 24 through the air supplying tube 25 (25a to 25h) to the air chambers 22 of the first to eighth ink cartridges 20a to 20h causes the first to eighth ink packs 23a to 23h to be squeezed. Subsequently, when the first to eighth ink passage valves 28a to 28h are open, the inks in the first to eighth ink packs 23a to 23h are pneumatically supplied through the first to eighth ink supplying tubes 27a to 27h correspondingly to the first to fourth valve units 18a to 18d, the first to fourth valve units 18a to 18d adjusting the pressures applied to the inks. Thus, the inks are supplied to the recording head 17.

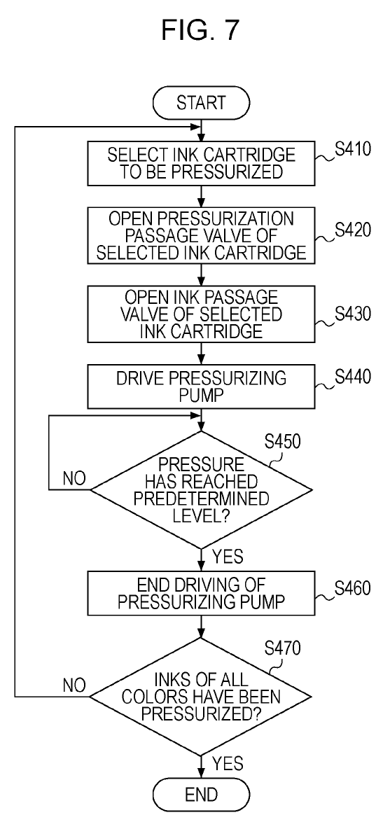

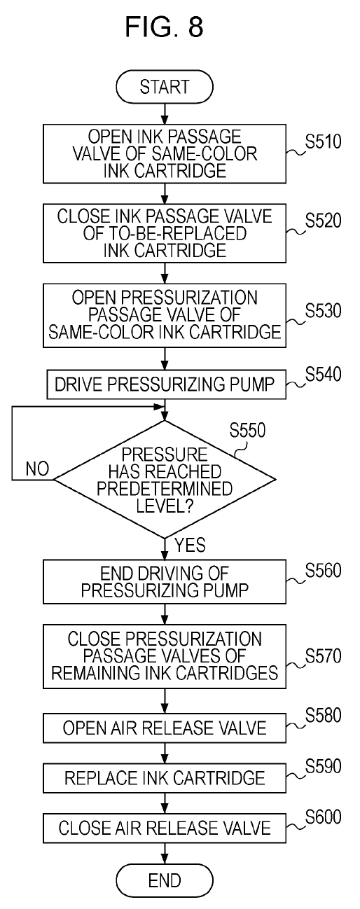

Now, control routines performed by the CPU 32 of the control device 31 will be described with reference to the flowcharts shown in FIGS. 7 and 8. The following description is based on the premise that, in the second embodiment, the amounts of ink remaining in the first to fourth ink packs 23a to 23d are smaller, with larger amounts of ink consumed, than the amounts of ink remaining in the fifth to eighth ink packs 23e to 23h.

When the power of the printer 10 is turned on, the CPU 32 performs a power-on routine shown in FIG. 7. Specifically, in step S410, the CPU 32 selects one of the first and fifth ink cartridges 20a and 20e containing the smaller amount of remaining black ink, i.e., the first ink cartridge 20a, to be used for printing, in accordance with information on the amount of remaining ink, the information being stored in a storage section (not shown) provided in each of the first to eighth ink cartridges 20a to 20h.

Subsequently, the CPU 32 controls a valve driving circuit (not shown) to open the first pressurization passage valve 26a in step S420 and to open the first ink passage valve 28a in step S430. In response to this, the pressurizing pump 24 and the air chamber 22 of the first ink cartridge 20a communicate with each other through the first air supplying tube 25a. This produces a state where the black ink is ready to be supplied to the recording head 17 with the driving of the pressurizing pump 24.

In this state, the CPU 32 performs subsequent steps S440 to S460, which are the same as steps S130 to S150 of the first embodiment shown in FIG. 4. Through these steps, pressurized air flows through the first air supplying tube 25a into the air chamber 22 of the first ink cartridge 20a, and pressurizes and squeezes the first ink pack 23a at a predetermined pressure, whereby the black ink in a pressurized state is supplied through the first ink supplying tube 27a to the recording head 17.

In subsequent step S470, the CPU 32 checks if all of the black, yellow, cyan, and magenta inks have been pressurized. If the yellow ink, for example, is yet to be pressurized (NO in step S470), step S410 is performed again in which the CPU 32 selects one of the second and sixth ink cartridges 20b and 20f containing the smaller amount of remaining yellow ink, i.e., the second ink cartridge 20b, to be used for printing. Then, steps S420 to S460 are performed as described above, whereby the yellow ink in a pressurized state is supplied from the second ink pack 23b through the second ink supplying tube 27b to the recording head 17.

When the cyan and magenta inks are also pressurized and supplied from the third and fourth ink packs 23c and 23d through the third and fourth ink supplying tubes 27c and 27d, respectively, to the recording head 17, it is regarded that the inks of all colors have been pressurized (YES in step S470). Then, the CPU 32 ends the routine.

When the pressure sensor 35 detects that the pressure inside the air supplying tube 25 (25a to 25h) has been reduced from a predetermined level to a predetermined lower limit, the CPU 32 drives the pressurizing pump 24 again. If the first to eighth pressurization passage valves 26a to 26h, the first to eighth ink passage valves 28a to 28h, and the air release valve 36 are open at the start of the power-on routine shown in FIG. 7, the CPU 32 causes the first to eighth pressurization passage valves 26a to 26h, the first to eighth ink passage valves 28a to 28h, and the air release valve 36 to be closed before performing step S410.

As the inks in the first to fourth ink packs 23a to 23d is consumed while being ejected from the recording head 17, the remaining amount of ink in any of the first to fourth ink packs 23a to 23d becomes zero, i.e., an ink end state. The ink end sensor 37 detects such an ink end state. In response to this, the CPU 32 identifies the relevant ink cartridge that needs to be removed for replacement, i.e., the to-be-replaced ink cartridge, in accordance with the result of detection performed by the ink end sensor 37. After the identification, the CPU 32 performs a replacement routine shown in FIG. 8.

The replacement routine will be described, taking as an example a case where the first ink cartridge 20a is identified as the to-be-replaced ink cartridge that needs to be removed for replacement.

When the replacement routine shown in FIG. 8 is started, in step S510, the CPU 32 controls the valve driving circuit to open the fifth ink passage valve 28e corresponding to the fifth ink cartridge 20e, which is the same-color ink cartridge corresponding to the first ink cartridge 20a identified as the to-be-replaced ink cartridge. In subsequent step S520, the CPU 32 controls the valve driving circuit to close the first ink passage valve 28a corresponding to the first ink cartridge 20a. In subsequent step S530, the CPU 32 controls the valve driving circuit to open the fifth pressurization passage valve 26e corresponding to the fifth ink cartridge 20e.

In response to the above operations, pressurized air in the air chambers 22 of the first to fourth ink cartridges 20a to 20d and the first to fourth air supplying tubes 25a to 25d flows into the air chamber 22 of the fifth ink cartridge 20e, whereby the pressure inside the air supplying tube 25 is reduced.

When the pressure sensor 35 detects that the pressure inside the air supplying tube 25 has been reduced to the predetermined lower limit, the CPU 32 performs subsequent steps S540 to S560, which are the same as steps S130 to S150 of the first embodiment shown in FIG. 4. Through these steps, pressurized air flows through the first to fifth air supplying tubes 25a to 25e into the air chambers 22 of the first to fifth ink cartridges 20a to 20e. The second to fifth ink packs 23b to 23e, in which the respective inks still remain, are pressurized and squeezed by the pressurized air at a predetermined pressure, whereby the inks in a pressurized state are supplied through the second to fifth ink supplying tubes 27b to 27e to the recording head 17.

Then, in step S570, the CPU 32 controls the valve driving circuit to close the second to fifth pressurization passage valves 26b to 26e respectively corresponding to the second to fifth ink cartridges 20b to 20e, which are the remaining ink cartridges.

In this state, the CPU 32 performs subsequent steps S580 to S600, which are the same as steps S230 to S250 of the first embodiment shown in FIG. 5. While these steps are performed, the first ink passage valve 28a is closed. Therefore, even if the first ink cartridge 20a is removed, the ink will not leak therefrom.

On the other hand, the air chambers 22 of the second to fifth ink cartridges 20b to 20e retain the pressurized air therein because the second to fifth pressurization passage valves 26b to 26e are closed, whereas the second to fifth ink passage valves 28b to 28e remain being open. Therefore, the inks in the remaining ink cartridges, i.e., the second to fifth ink cartridges 20b to 20e, can continue to be supplied to the recording head 17.

Now, advantageous effects produced by the ink supplying system 200 included in the printer 10 configured as above will be described, focusing on effects obtained in relation to removal and replacement of an ink cartridge.

The following description is based on the premise that the first to fourth pressurization passage valves 26a to 26d and the first to fourth ink passage valves 28a to 28d corresponding to the first to fourth ink cartridges 20a to 20d are all open, whereas the fifth to eighth pressurization passage valves 26e to 26h and the fifth to eighth ink passage valves 28e to 28h corresponding to the fifth to eighth ink cartridges 20e to 20h are all closed.

On this premise, if the remaining amount of ink in any of the first to fourth ink cartridges 20a to 20d shows the ink end state, the relevant ink cartridge in the ink end state needs to be removed for replacement with a new one containing the same ink.

For example, a case where the first ink cartridge 20a containing the black ink is identified as the to-be-replaced ink cartridge that needs to be removed for replacement will be described. To begin with, the fifth ink passage valve 28e corresponding to the fifth ink cartridge 20e containing the same black ink is opened. In this state, since the fifth pressurization passage valve 26e is closed, the air chamber 22 of the fifth ink cartridge 20e is not pressurized while the small amount of ink remaining in the first ink pack 23a is free to flow through the first ink supplying tube 27a into the fifth ink supplying tube 27e. To avoid this, the first ink passage valve 28a is closed and the fifth pressurization passage valve 26e is opened, whereby the forces of pressurizing the interiors of the air chambers 22 of the first to fifth ink cartridges 20a to 20e are made uniform. Thus, the ink in the first ink cartridge 20a is prevented from flowing into the fifth ink cartridge 20e.

Subsequently, when the pressurizing pump 24 is driven, the pressure inside the air supplying tube 25 that has been reduced at the opening of the fifth pressurization passage valve 26e is increased again to the predetermined level. This is to enable the inks in the second to fifth ink cartridges 20b to 20e to be supplied through the second to fifth ink passage valves 28b to 28e, which are open, to the recording head 17.

On the other hand, the second to fifth pressurization passage valves 26b to 26e of the second to fifth air supplying tubes 25b to 25e respectively corresponding to the second to fifth ink cartridges 20b to 20e, which are the remaining ink cartridges that do not need to be removed for replacement, are closed. This is because of the following reason. Before the first ink cartridge 20a is removed for replacement, the air release valve 36 is opened. When the air release valve 36 is opened, pressure change, i.e., depressurization to atmosphere, occurs in the air supplying tube 25 (25a to 25h). This pressure change needs to be prevented from affecting the air chambers 22 of the second to fifth ink cartridges 20b to 20e.

After the second to fifth pressurization passage valves 26b to 26e are all closed, the air release valve 36 is opened. In response to this, the interior of the air chamber 22 of the first ink cartridge 20a in the ink end state is depressurized to atmosphere. In this state, the first ink cartridge 20a can be replaced with a new one without any leakage of ink from the first ink pack 23a when removed from the cartridge holder 19.

On the other hand, the interiors of the air chambers 22 of the second to fifth ink cartridges 20b to 20e, which are the remaining ink cartridges, continues to be pressurized. Therefore, the inks continue to be pneumatically supplied, without any interruptions, from the second to fifth ink cartridges 20b to 20e to the recording head 17 even during the replacement of the first ink cartridge 20a.

According to the second embodiment, the following advantageous effect can be produced, as well as the advantageous effects (1) to (5) produced in the first embodiment.

(7) In a case where the in-use one of the first and fifth ink cartridges 20a and 20e containing the black ink, i.e., the first ink cartridge 20a, needs to be removed for replacement, the ink supplying route, along which the black ink is supplied toward the downstream position where the ink is consumed, is switched from the first ink supplying tube 27a to the fifth ink supplying tube 27e before the first ink cartridge 20a is removed. This enables continuous supply of the black ink to the recording head 17 using the fifth ink cartridge 20e, without any interruptions, even during replacement of the first ink cartridge 20a containing the black ink.

The first and second embodiments may be modified as follows.

In the first and second embodiments, the position where the air release valve 36 is disposed may be modified. Specifically, in the first embodiment, the air release valve 36 may be provided to each of the first to fourth air supplying tubes 25a to 25d at a position between corresponding one of the first to fourth ink cartridges 20a to 20d and corresponding one of the first to fourth pressurization passage valves 26a to 26d. This modification is hereinafter referred to as a first modification. In the second embodiment, the air release valve 36 may be provided to each of the first to eighth air supplying tubes 25a to 25h at a position between corresponding one of the first to eighth ink cartridges 20a to 20h and corresponding one of the first to eighth pressurization passage valves 26a to 26h. This modification is hereinafter referred to as a second modification.

In the first modification, for example, when the first ink cartridge 20a needs to be removed for replacement, the CPU 32 controls the valve driving circuit to close the first pressurization passage valve 26a and the first ink passage valve 28a corresponding to the first ink cartridge 20a. Subsequently, the CPU 32 causes the air release valve 36 provided to the first air supplying tube 25a to be opened. In the second modification, for example, when the first ink cartridge 20a needs to be removed for replacement, the CPU 32 controls the valve driving circuit to close the first pressurization passage valve 26a and the first ink passage valve 28a corresponding to the first ink cartridge 20a, and to open the fifth pressurization passage valve 26e and the fifth ink passage valve 28e corresponding to the fifth ink cartridge 20e. Subsequently, the CPU 32 causes the air release valve 36 provided to the first air supplying tube 25a to be opened.

In each of the modifications, while the foregoing air release valve 36 is open, the first pressurization passage valve 26a corresponding to the first ink cartridge 20a, which needs to be removed for replacement, is closed. Therefore, only the interior of the air chamber 22 of the first ink cartridge 20a is depressurized, i.e., released, to be equal to atmosphere. Thus, even during replacement of the first ink cartridge 20a, the inks can continue to be supplied from the second to fourth ink cartridges 20b to 20d (or the second to fifth ink cartridges 20b to 20e) to the recording head 17.

More specifically, a case where the first ink cartridge 20a is removed after the air release valve 36 provided to the first air supplying tube 25a corresponding to the first ink cartridge 20a, which needs to be replaced, is opened will be considered. If the entirety of the air supplying tube 25 (25b to 25h) is released to atmosphere through the first air supplying tube 25a corresponding to the first ink cartridge 20a, the inks cannot be pneumatically supplied from the second to fifth ink cartridges 20b to 20e to the recording head 17. To avoid this, in the second modification for example, the control device 31 controls the open/closed states of the first to eighth pressurization passage valves 26a to 26h in such a manner that, before the air release valve 36 provided to the first air supplying tube 25a corresponding to the first ink cartridge 20a is opened, the first pressurization passage valve 26a corresponding to the first ink cartridge 20a is closed and the second to fifth pressurization passage valves 26b to 26e corresponding to the second to fifth ink cartridges 20b to 20e are opened. Therefore, even during replacement of the first ink cartridge 20a, the inks can continue to be pneumatically supplied from the second to fifth ink cartridges 20b to 20e toward the downstream position.

Moreover, since the section that is to be depressurized during replacement of the first ink cartridge 20a is smaller in the modifications than in the embodiments in which only a single air release valve 36 is provided to the air supplying tube 25. Therefore, the predetermined pressure can be quickly regained after replacement of an ink cartridge.

In configurations such as the first and second modifications, the air release valve 36 serving as a depressurizer may be omitted. Instead, a depressurizing mechanism in which air is released to atmosphere when any of the first to eighth ink cartridges 20a to 20h is removed from the cartridge holder 19 may be employed. In such a case, to prevent the first to eighth ink cartridges 20a to 20h from jumping out of the cartridge holder 19 because of the pressurizing force, it is desirable to provide a first stopper that allows the shift from a state where the first to eighth ink cartridges 20a to 20h are mounted in a pressurized state on the cartridge holder 19 to a state where the first to eighth ink cartridges 20a to 20h are released to atmosphere, and a second stopper that allows the shift from a state where the first to eighth ink cartridges 20a to 20h are released to atmosphere to a state where the first to eighth ink cartridges 20a to 20h can be removed. Further, it is desirable that, in the state where the first to eighth ink cartridges 20a to 20h are released to atmosphere, the first to eighth ink supplying tubes 27a to 27h are connected to the first to eighth ink packs 23a to 23h, respectively.

In the first and second embodiments, air releasing may be performed by, after ending the driving of the pressurizing pump 24, closing some of the first to eighth pressurization passage valves 26a to 26h corresponding to necessary ones of the first to eighth ink cartridges 20a to 20h from which ink will continue to be supplied to the recording head 17. Thus, the inks can continue to be pressurized so as to be supplied, and the load applied to passage-forming members that form the pressurization passages can be reduced.

In the first and second embodiments, the ink end sensor 37 may be omitted. Instead, the necessity of replacing any of the first to eighth ink cartridges 20a to 20h may be determined by estimating the amount of remaining ink from, for example, the amount of ink consumed in printing and the like.

In the first embodiment, the first to fourth ink passage valves 28a to 28d may be omitted. Further, in the first and second embodiments, the first to eighth ink passage valves 28a to 28h may be one-way valves (check valves) that only allow the passage of the inks from the first to eighth ink cartridges 20a to 20h to the recording head 17.

In the first and second embodiments, the air release valve 36 may not necessarily be controlled by the control device 31 to be opened. For example, the air release valve 36 may be manually operated for air releasing by a user of the printer 10 who will replace any of the first to eighth ink cartridges 20a to 20h.

In the first and second embodiments, the first to eighth ink cartridges 20a to 20h may not necessarily include the first to eighth ink packs 23a to 23h, and may each include an ink storage chamber provided as a section defined in the case 21. In such a case, the ink is stored in the ink storage chambers, and the first to eighth ink supplying tubes 27a to 27h may be provided in correspondence therewith and be connected to the respective cases 21.

In the first and second embodiments, the CPU 32 may calculate the period of driving the pressurizing pump 24 on the basis of information stored in the RAM 34 on the amounts of ink remaining in the first to eighth ink cartridges 20a to 20h by a calculating method stored in advance in the ROM 33. Thus, the inks can be pneumatically supplied at a predetermined pressure without the pressure sensor 35.

Although the first and second embodiments concern the case where the liquid ejecting apparatus of the invention including the ink supplying system is embodied in the form of the ink jet printer 10, the invention is not limited thereto. The invention may also be embodied in the form of a liquid ejecting apparatus that ejects liquid other than ink (such as a solution in which particles of a functional material are dispersed). Other exemplary apparatuses include the following: a liquid ejecting apparatus that ejects a solution in which a material such as an electrode material or a colorant used in manufacturing a liquid crystal display, an electroluminescence (EL) display, or a surface emission display is dispersed or dissolved; a liquid ejecting apparatus that ejects a bioorganic substance used in manufacturing a biochip; and a liquid ejecting apparatus that is used as a precision pipette and ejects liquid as a sample. The ink supplying system of the invention can be applied to any of the foregoing liquid ejecting apparatuses.

The entire disclosure of Japanese Patent Application No. 2008-007093, filed Jan. 16, 2008 is expressly incorporated by reference herein.

What is claimed is:

1. A liquid supplying system comprising:
a pressurized-fluid passage having in a downstream portion thereof a plurality of branches connected in parallel respectively to a plurality of liquid containers containing liquid, the branches allowing pressurized fluid to be supplied to the individual liquid containers;
a liquid supplying passage having in an upstream portion thereof a plurality of branches connected in parallel to the respective liquid containers, the branches allowing the liquid to be supplied from the individual liquid containers toward a downstream position where the liquid is consumed;
a plurality of pressurization passage valves provided in the respective branches of the pressurized-fluid passage;
a depressurizer configured to be driven so as to depressurize an interior of the pressurized-fluid passage; and
a control section capable of controlling individual open or closed states of the pressurization passage valves,
wherein, in a case where the depressurizer is driven so as to enable removal of any of the liquid containers for replacement in a state where the pressurized fluid is supplied through the pressurized-fluid passage to the individual liquid containers, the control section controls the individual open or closed states of the pressurization passage valve corresponding to a to-be-replaced liquid container that is to be removed for replacement and the pressurization passage valve corresponding to a remaining liquid container that continues to be used to become opposite to each other.

2. The liquid supplying system according to claim 1,
wherein the liquid containers include a plurality of same-kind liquid containers containing liquid of a same kind and at least one liquid container containing liquid of a different kind from that in the same-kind liquid containers, the same-kind liquid containers including an in-use same-kind liquid container to which the pressurized fluid is supplied through the pressurized-fluid passage so that the liquid is supplied through the liquid supplying passage to the downstream position and a standby same-kind liquid container for which supply of the pressurized fluid is being withheld, and
wherein, in a case where the to-be-replaced liquid container is the in-use same-kind liquid container, the control section controls the individual open or closed states of the pressurization passage valve corresponding to the in-use same-kind liquid container and the pressurization passage valves corresponding to the remaining liquid containers including the standby same-kind liquid container to become opposite to each other.

3. The liquid supplying system according to claim 1,
wherein the depressurizer is disposed in an upstream portion of the pressurized-fluid passage with respect to the pressurization passage valves, and
wherein, in a case where the depressurizer depressurizes the interior of the pressurized-fluid passage so that the to-be-replaced liquid container is removed for replacement, the control section controls the pressurization passage valve corresponding to the to-be-replaced liquid container to be opened and the pressurization passage valve corresponding to the remaining liquid container to be closed.

4. The liquid supplying system according to claim 1, wherein the depressurizer is controlled to be driven by the control section, the control section driving the depressurizer, before the to-be-replaced liquid container is removed for replacement, after controlling the individual open or closed states of the pressurization passage valves.

5. The liquid supplying system according to claim 1, further comprising:
a plurality of liquid passage valves provided to the respective branches of the liquid supplying passage,
wherein, before the to-be-replaced liquid container is removed for replacement, the control section controls the liquid passage valve corresponding to the to-be-replaced liquid container to be closed and the liquid passage valve corresponding to the remaining liquid container to be opened.

6. The liquid supplying system according to claim 1, further comprising:
a remaining-liquid-amount detector that detects amounts of liquid remaining in the liquid containers,
wherein the control section identifies the to-be-replaced liquid container among all of the liquid containers in accordance with a result of detection performed by the remaining-liquid-amount detector.

7. The liquid supplying system according to claim 1,
wherein the depressurizer is provided to each of the branches of the pressurized-fluid passage, between corresponding one of the pressurization passage valves and corresponding one of the liquid containers, and
wherein, in a case where the depressurizer provided to the branch corresponding to the to-be-replaced liquid container depressurizes the interior of the branch so that the to-be-replaced liquid container is removed for replacement, the control section controls the pressurization passage valve corresponding to the to-be-replaced liquid container to be closed and the pressurization passage valve corresponding to the remaining liquid container to be opened.

8. A liquid ejecting apparatus comprising:
a liquid ejecting head that ejects liquid; and
the liquid supplying system according to claim 1 that supplies the liquid to the liquid ejecting head.

9. A liquid supplying method comprising:
pneumatically supplying liquid from a plurality of liquid containers containing the liquid through a liquid supplying passage toward a downstream position where the liquid is consumed, by supplying pressurized fluid through a pressurized-fluid passage to the liquid containers,
wherein supply of the pressurized fluid through the pressurized-fluid passage to the liquid containers is performed independently for the individual liquid containers, and
wherein, in a case where depressurization of an interior of the pressurized-fluid passage is performed so that any of the liquid containers is removed for replacement, the depressurization is performed in such a manner that a remaining liquid container other than a to-be-replaced liquid container that is to be removed for replacement is free from an effect of pressure change resulting from the depressurization.
